(19) United States
(12) Patent Application Publication
(10) Pub. No.: US 2026/0003677 A1
(43) Pub. Date: Jan. 1, 2026

(54) PARTITIONED STORE QUEUE ENGINE IN A SEMICONDUCTOR SYSTEM

(71) Applicant: Microsoft Technology Licensing, LLC, Redmond, WA (US)

(72) Inventors: Dushyanth BHOJARAJA, Fremont, CA (US); Paul Alan BEAZLEY, Denver, CO (US)

(21) Appl. No.: 18/759,569

(22) Filed: Jun. 28, 2024

(51) Int. Cl. G06F 9/50

(52) U.S. Cl. CPC G06F 9/5011

(57) ABSTRACT

Methods, systems, and devices for providing partitioned store queue management using a partitioned store queue engine of a semiconductor system are described. Partitioned store queue management can refer to hardware-based techniques associated with a store queue architecture that helps managing memory operations, including storing of data to memory. Hardware-based techniques are employed to handle store instructions in a processor pipeline. In operation, a control store queue entry is allocated in a control store queue of a partitioned store queue when a store instruction is in a decode-dispatch stage. A data store queue entry is allocated when the store instruction in a memory stage of the processor pipeline. The data store queue is freed up when the data is ready in the data store queue entry. The control queue entry and data store queue entry is deallocated when the store instruction is in a write back stage of the processor pipeline.

### BACKGROUND

Users rely on electronic devices (e.g., computing devices with applications and services) to perform different types of tasks. Computing systems use artificial intelligence (AI) to enhance functionality, efficiency, and capabilities across numerous applications and services. Computing systems use AI to automate tasks, analyze data, personalize user experiences, and enable advance functionality across various domains. Computing systems may be integrated with AI accelerators or AI System on Chip (SoCs) that provide necessary specialized hardware to handle demanding computations of AI tasks efficiently. For example, Graphics Processing Units (GPUs), Tensor Processing Units (TPUs), Field-Programmable Gate Arrays (FPGAs), Application-Specific Integrated Circuits (ASICs), Neural Processing Units (NPUs) can be provided as AI hardware to speed up specific computations (e.g., processing large datasets and complex algorithms used in AI and machine learning) to enhance overall performance and efficiency of computing systems.

### SUMMARY

Various aspects of the technology described herein are generally directed to systems, methods, and devices for, among other things, providing partitioned store queue management using a partitioned store queue engine of a semiconductor system Partitioned store queue management can refer to hardware-based techniques associated with a store queue architecture that helps managing memory operations, including storing of data to memory. The hardware-based techniques and mechanisms are employed to handle store instructions in a processor pipeline. In particular, partitioned store queue management manages entries in a partitioned store queue that includes a control store queue and a data store queue for ensuring proper sequencing and execution of store operations, resolving dependencies, and maintaining data consistency and coherence. The store queue architecture may, in one example, be associated with AI hardware (e.g., an AI accelerator or AI System on Chip “SoC”).

The partitioned store queue engine supports a control store queue and a data store queue. The partitioned store queue engine may provide a partitioned store queue control engine for allocating and deallocating control store queue entries and data store queue entries that correspond to the control store queue and the data store queue. For a store instruction, a control store queue entry is allocated in a decode-dispatch stage of the processing pipeline and deallocated in the write back stage of the processor pipeline; and a data store queue entry is allocated when the store instruction is in the memory stage of the processor pipeline. A vector execution pipeline is run to populate data store queue entry fields of the data store queue, when the data becomes available. The data store queue entry can be released or deallocated in combination with the control store queue entry. The partitioned store queue engine supports a load data stall extension that leverages an existing load data stall mechanism when the data store queue is full. By way of illustration, if the store instruction is in the memory stage of the processor pipeline and the data store queue is full, the partition store queue engine employs the load data stall to stall the processor pipeline.

Conventional semiconductor systems are not configured with logic and infrastructure for sustained throughput for stores in vector processors. A store queue supports vector processors by managing the timing and ordering of data writes to memory, ensuring high throughput and hiding memory access latency during single instruction multiple data (SIMD) operations. To prevent WAW (write after write) memory hazards, both in-order and out-of-order processors use store queues to ensure correct data ordering. Store instructions generate data through other instructions with varying delays, and each store queue entry holds the memory address, data, and control information. The store queue length corresponds to the number of pipeline stages between the decode-dispatch and write-back stages, necessitating more entries as pipelines deepen and processors speed up, leading to potential stalls if the queue is full. As vector processors evolve with deeper pipelines and wider SIMD widths, the conventional semiconductor system store queues are not optimized to handle increased data demands, posing challenges in efficiency, silicon area, and power consumption.

A technical solution – to the limitations of conventional store queue architecture systems – can include providing partitioned store queue resources via a partitioned store queue engine that supports partitioned store queue management in a semiconductor system. Partitioned store queue management can be provided using a store queue management logic for a store queue partitioned into a control store queue and a data store queue associated with a processor pipeline and a vector execution pipeline. Moreover, a load data stall extension that is based on an existing load data stall mechanism for load instructions can be implemented to handle the data store queue when it is full. The data queue size can correspond to the depth of the vector execution pipeline stage. In this way, a vector processor can achieve a throughput of one load and one store operation per cycle in a vector processor implies that the vector processor can fetch data from memory and write data back to memory at a rate of one operation per clock cycle.

In operation, in a first embodiment, a control store queue entry is allocated in a control store queue of a partitioned store queue when a store instruction is in a decode-dispatch stage. A data store queue entry is allocated when the store instruction in a memory stage of the processor pipeline. The control queue entry is deallocated when the store instruction is in a write back stage of the processor pipeline. The data store queue entry is deallocated in combination with the control store queue entry.

In a second embodiment, a determination is made that a store instruction is in a memory stage of a processor pipeline. The processor pipeline is associated with a partitioned store queue comprising a control store queue and a data store queue. A determination is made that the data store queue is full. The processor pipeline is stalled based on a load data stall extension associated with a load data stall for load instructions in the processor pipeline.

In a third embodiment, a semiconductor system is provided. The semiconductor system includes a partitioned store queue having a control store queue and data store queue associated with a processor pipeline. A control store queue entry is allocated when a store instruction is in a decode-dispatch stage of the processor pipeline and deallocated when the store instruction is in a write back stage of the processor pipeline; and a data store queue entry is allocated when a store instruction is in a memory stage of the processor pipeline and deallocated based on a vector execution pipeline of the processor pipeline providing data associated with the store instruction.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIG. 1 is a block diagram of an exemplary semiconductor system including a partitioned store queue engine, in accordance with aspects of the technology described herein;

FIG. 2 is a block diagram of an exemplary semiconductor system including a partitioned store queue engine, in accordance with aspects of the technology described herein;

FIG. 3 provides a first exemplary method of providing partitioned store queue management using a partitioned store queue engine, in accordance with aspects of the technology described herein;

FIG. 4 provides a second exemplary method of providing partitioned store queue management using a partitioned store queue engine, in accordance with aspects of the technology described herein;

FIG. 5 provides a third exemplary method of providing partitioned store queue management using a partitioned store queue engine, in accordance with aspects of the technology described herein;

FIG. 6 provides a block diagram of an exemplary AI backend network system suitable for use in implementing aspects of the technology described herein;

FIG. 7 provides a block diagram of an exemplary distributed computing environment suitable for use in implementing aspects of the technology described herein; and

FIG. 8 provides a block diagram of an exemplary computing environment suitable for use in implementing aspects of the technology described herein.

### DETAILED DESCRIPTION

### OVERVIEW

A store queue is a hardware buffer in a processor that temporarily holds store instructions and their associated data before writing them to memory. The store queue ensures data is written in the correct order to prevent hazards, such as WAW (write after write). The store queue manages entries from the decode-dispatch stage to the write-back stage of the pipeline, stalling new entries if the queue is full – and as a result, stalling the processor pipeline. Load and store instructions enable processors to read from and write to memory. In typical workloads, data resides in the main memory and is transferred to the processor’s local memory and registers via load instructions when computation is required. Once the computation is complete, store instructions write the data back to the main memory.

A vector processor is a type of processor that can process multiple data points simultaneously using single instruction multiple data (SIMD) architecture, greatly enhancing performance for data-parallel tasks. The vector processor operates by applying the same operation to multiple data elements stored in vector registers, making it ideal for applications in scientific computing, graphics, and machine learning. A vector processor is designed to perform operations on multiple data elements simultaneously, whereas a traditional processor executes instructions sequentially on individual data elements using scalar operations. This fundamental difference in architecture allows vector processors to process larger data sizes efficiently in parallel, making them well-suited for tasks involving data-intensive computations such as scientific simulations and multimedia processing. In contrast, traditional processors handle smaller data sizes sequentially, limiting their ability to exploit parallelism and process large datasets as effectively as vector processors. Vector processors achieve high throughput by leveraging wide data paths and parallel execution units, efficiently handling large volumes of data per clock cycle.

Stalls in vector processors can significantly impact the utilization of compute units. When a stall occurs, compute units may be left idle or underutilized, as they are unable to receive new instructions or data to process. This results in decreased throughput and performance efficiency, as compute units are not fully utilized to execute operations on data. Additionally, stalls can introduce latency in the execution of vector instructions, potentially causing delays in completing computational tasks. Overall, minimizing stalls in vector processors is crucial for maximizing the efficiency and throughput of compute units and optimizing overall performance.

Store queues in vector processors manage the timing and ordering of data writes to memory, essential for high-throughput SIMD operations. When vector processors are integrated into AI accelerators and AI System on Chip (“SoCs”) (collectively “AI hardware”), proximity of stacked memory and processing layers reduces data transfer latency and increases bandwidth, enhancing store queue efficiency. This integration supports the increased data demands and deeper pipelines of modern vector processors, optimizing performance and power efficiency.

Conventional semiconductor systems and AI hardware are not configured with logic and infrastructure for adequate and efficient store queue management for vector processors. A store queue supports operations of vector processors, which handle large volumes of data through SIMD (Single Instruction, Multiple Data) operations. The store queue buffers store operations, managing the timing and ordering of data writes to memory, thus hiding memory access latency and ensuring high throughput. As vector processors evolve with deeper pipelines and wider SIMD widths, the store queue can be optimized to accommodate increased data and operational demands, posing challenges in maintaining efficiency, silicon area, and power consumption.

To prevent WAW (write after write) memory hazards, both in-order and out-of-order processors use store queues to ensure data is written to memory in the correct order. Store instructions may generate data through other instructions that experience different delays in the processor pipeline. Each store queue entry holds the memory address, the data to be written, and control information necessary for coordination. The length of the store queue typically corresponds to the number of pipeline stages between the decode-dispatch stage, where the store queue entry is allocated, and the write-back stage, where it is deallocated. If the store queue is full, a stall occurs at the decode-dispatch stage until entries free up. As processors become faster and more deeply pipelined, the gap between these stages increases with each new version, necessitating a larger number of store queue entries.

Vector processors process large amounts of data each cycle, necessitating high-bandwidth loads to input substantial data and stores to output it, ensuring the vector compute units remain well-utilized. To maintain throughput, the vector execution pipeline stages commence after the memory stage of the pipeline. Due to deeper pipelines and the nature of SIMD, each processor revision demands a larger store queue size because memory accesses take longer, execution units take longer, and more pipelining is required due to shorter time available in each clock cycle. For example, if the pipeline depth increases from 8 to 16 stages and the SIMD width increases from 64B to 128B, the store queue size expands from 512B to 2KB, representing a fourfold increase. This exponential growth in store queue size with each revision becomes unsustainable over time.

The rise is area for store queues in vector processors create challenges in silicon overhead, power consumption, and complexity and design trade-offs. For example, increasing the size of store queues to accommodate higher throughput and deeper pipelines results in greater silicon area consumption. This poses a challenge in terms of cost-effectiveness and chip fabrication, as larger store queues require more physical space on the semiconductor die. Larger store queues can lead to increased power consumption, as more circuitry is required to support their operation. This can impact energy efficiency and battery life in portable devices, where power consumption is a critical concern. Moreover, as store queues grow in size, the complexity of managing them also increases. Designers must balance the need for larger queues with the trade-offs in terms of performance, area, and power. This involves careful optimization and trade-off analysis to ensure that the benefits of larger store queues outweigh the associated costs and design complexities. As such, a more comprehensive semiconductor system – with an alternative basis for performing font store queue management – can improve computing operations AI hardware.

### DESCRIPTION OF TECHNICAL SOLUTION

At a high level, a partitioned store queue and logic is provided via a partitioned store queue engine associated with an AI hardware (e.g., AI accelerator or AI SoC) to optimize managing the timing and order of data write operations to memory, ensuring efficient and correct execution of store instructions in a processor pipeline. By way of illustration, a store queue is partitioned into two store queues – a control store queue and a data store queue. The control store queue is allocated in a decode dispatch stage of a processor pipeline and deallocated in the write back stage of the processor pipeline. The partitioned store queue comprising the control store queue is allocated at the decode-dispatch stage because at the decode-dispatch stage the processor pipeline decodes an instruction and determines that the instruction is a store instruction. The data store queue is allocated at a memory stage of a processor pipeline. The processor pipeline begins and fills in data in the data store queue entry fields when data is ready or has been retrieved from memory and is available for further processing in the processor pipeline. The data store queue is freed up when the data is ready in the data store queue entry and the data store queue entry is at the head of the line. A load data stall extension that leverages an existing load data stall for load instructions stalls the processor pipeline when the data store queue is full, until is the data store queue is no longer full.

By way of context, a vector processor pipeline is a series of stages that process SIMD (Single Instruction, Multiple Data) instructions to handle large volumes of data efficiently. The stages typically include the Instruction Fetch Unit (IFU), where instructions are retrieved from memory, and the Instruction Decode Unit (IDU), where instructions are decoded and dispatched. Next, the operands are fetched from the Vector Register File (VRF) in the operand fetch stage, followed by the Execution stage where Vector Functional Units (VFUs) perform arithmetic and logical operations on the vector data.

In the context of a store instruction with the current technical solution, at the decode-dispatch stage, a store instruction requires control information such as the memory address where the data will be written and the actual data to be stored. Additionally, the store instruction needs details on instruction type, dependency information to avoid hazards, and pipeline control signals to manage the flow of the instruction. This information ensures accurate data storage, correct sequencing, and efficient execution within the processor pipeline. A control store queue support the store instruction at the decode-dispatch stage.

Once the instruction reaches the memory stage, the data to be stored is prepared and queued in the in the data queue store. The vector execution pipeline ensures that the data from vector computations is correctly placed in the data store queue. During this stage, the data store queue buffers the store operation, holding the memory address, data, and control information to manage the timing and order of the writes. If the store instruction is the memory stage of the pipeline processor pipeline and the data store queue is full, a load data stall extension stalls the processor pipeline until the data store queue is no longer full.

After the memory stage, the store instruction moves to the write back stage, where the actual data transfer to memory occurs, coordinated by the Load-Store Unit (LSU). The control store queue helps to manage these operations, ensuring data is written to memory in the correct sequence to prevent hazards. Once the data is written back to memory, the store control store queue entry is deallocated, freeing it up for future store operations.

With the partitioned store queue, the data store queue needs to be sized only to the depth of the vector execution pipeline stages which depends on the following: reading the vector registers (e.g., 1-2 cycles); worse latency of the vector execution unit (e.g., “N”- cycles); and pipeline stages required to move the data to store queues (e.g., 1-2 cycles). For example, if the worst-case latency of a vector execution unit is 5-cycles, the data store queue entry should be sized to 9 entries (2 + 5 + 2 = 9 entries (pessimistic), 1 + 5 + 1 = 7 entries (optimistic)). With the SIMD width of 128B, the data store queue can be sized to (9x128B=1152B). This saves the area by removing the number of entries equivalent to the distance between decode-dispatch stage to the memory stage of the processor pipeline and retaining a sustained throughput for the store instruction without any bubbles in the pipeline.

Sustained throughput for store instructions refers to the consistent rate at which data can be written to memory over an extended period of time. It indicates the ability of the processor's memory subsystem to handle a continuous stream of store operations without experiencing significant delays or bottlenecks. Achieving sustained throughput for store instructions involves optimizing various factors, such as memory access latency, store queue capacity, memory bandwidth, and overall system performance, to ensure efficient and uninterrupted data transfer from the processor to memory. Sustained throughput can be provide via a partitioned store queue and corresponding logic.

The partitioned store queue enables achieving a throughput of one load and one store operation per cycle. Achieving a throughput of one load and one store operation per cycle in a vector processor implies that the processor can fetch data from memory and write data back to memory at a rate of one operation per clock cycle. This means that every cycle, the processor can initiate a memory load operation to fetch data from memory into its registers and simultaneously execute a memory store operation to write data from its registers back to memory. Overall, achieving a throughput of one load and one store operation per cycle requires a well-designed and highly optimized vector processor architecture with robust memory subsystem support and efficient memory access mechanisms. As such, the partitioned store queue operates as a store queue architecture optimization for improving the design and functionality of the store queue within a processor to enhance performance, efficiency, and resource utilization. This optimization involves various techniques and strategies aimed at implementing efficient control logic, and integrating advanced features for providing sustained throughput and improving the overall performance.

### EXAMPLE SYSTEMS AND RESOURCES

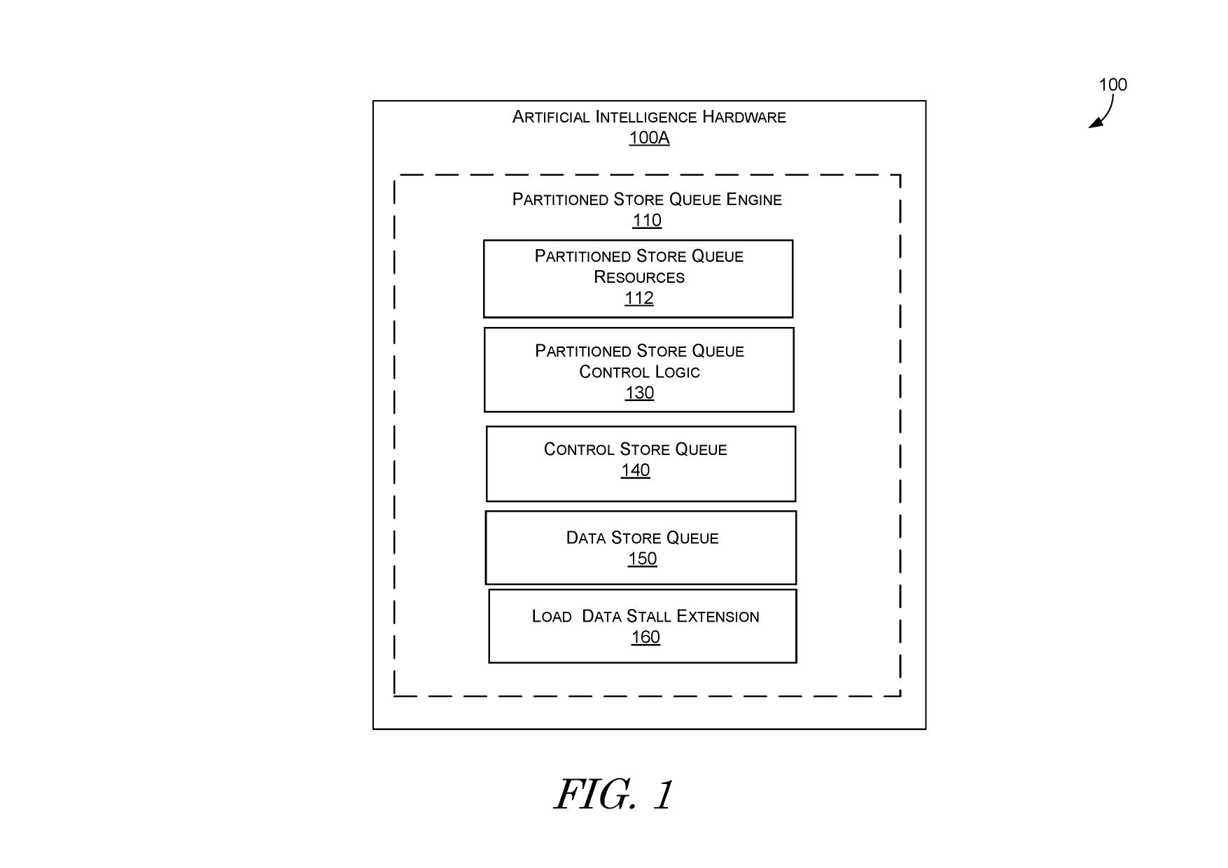

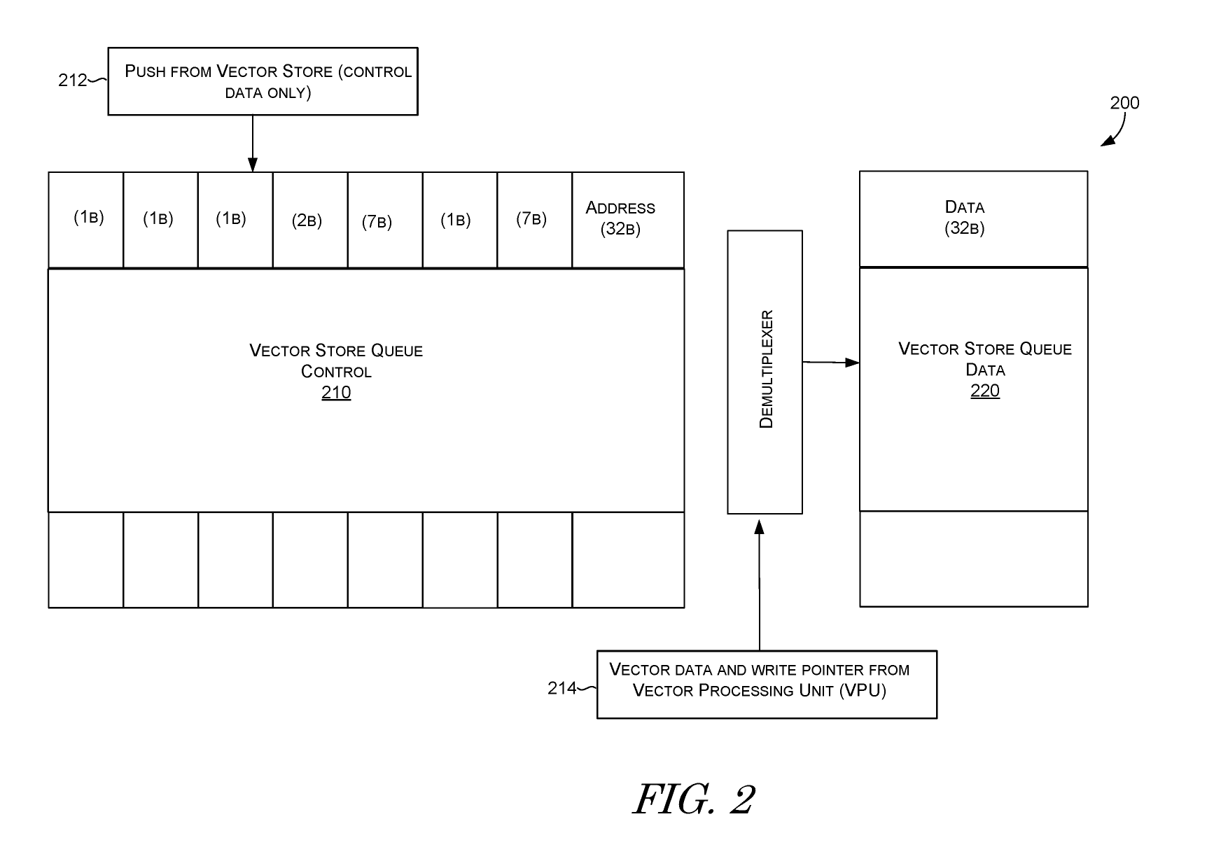

Aspects of the technical solution can be described by way of examples and with reference to FIGS. 1 and 2. FIG. 1 illustrates an example semiconductor system 100 with an artificial intelligence hardware 100A and partitioned store queue engine 100 including partitioned store queue resources 112, partitioned store queue control logic, control store queue 140, data store queue 150, and load data stall extension 160.

The partitioned store queue engine 100 is designed for store queue optimization based on partitioned store queue resources 112 that include operations, interfaces, and types of data for providing partitioned store queue management functionality. The primary operations involve buffering store instructions, managing their timing and order before writing data to memory. The partitioned store queue engine 100 handles the queuing, scheduling, and execution of these instructions to optimize memory write performance and prevent hazards. The partitioned store queue engine 100 also ensures that dependencies are managed and store operations are correctly ordered to maintain data integrity.

The interfaces of a partitioned store queue engine 100 connect various components of the system. The store queue interfaces with the processor pipeline, receiving store instructions and associated control data from the decode-dispatch stage. Partitioned store queue engine 100 connects to the memory subsystem to provide the data and addresses for write operations once the store instructions are ready for execution. Additionally, the queue interacts with partitioned store queue control logic 130 to manage the allocation and deallocation of entries, handle stalls, and coordinate the timing of store operations.

The data associated with a partitioned store queue engine 100 includes the memory address where the data is to be written, the actual data that needs to be written to the specified memory address, and control information such as instruction type, dependency flags, and timing details to manage the store operation correctly. This comprehensive data management ensures that store operations are executed efficiently and accurately.

Partitioned store queue control logic within the partitioned store queue engine 100 governs the operation and management of the control store queue 140 and data store queue 150. Partitioned store queue control logic allocates entries for incoming store instructions, handles dependencies and hazards by monitoring and resolving conflicts, and coordinates the timing of store operations to ensure they are executed in the correct order and at the appropriate time. Partitioned store queue control logic also manages stalls and initiates pipeline stages to free up queue entries, maintaining efficient throughput and optimizing the overall performance of the store operations. Stall can be managed via load data stall extension 160 that handles the processor pipeline when a data store queue is at capacity.

With reference to FIG. 2, FIG. 2 illustrates an example schematic of a partitioned storage queue architecture 100 (e.g., partition store queue engine) with a control store queue (i.e., vector store queue control 210) and a data store queue (i.e., vector store queue data 220). Vector store queue control 210 receives a push from vector store (control data only) 212 and the vector store queue control 220 receives vector data and write point from a vector processing unit 214. As such, the partitioned store queue engine supports a control store queue and a data store queue. The partitioned store queue engine may provide a partitioned store queue control engine for allocating and deallocating control store queue entries and data store queue entries that correspond to the control store queue and the data store queue.

A control store queue entry is allocated when a storage instruction is in a decode-dispatch stage of the processing pipeline and deallocated when the storage instruction is in the write back stage of the processor pipeline; and a data store queue entry is allocated when the store instruction is in the memory stage of the processor pipeline. A vector execution pipeline is run to populate data store queue entry fields of the data store queue, when the data becomes available. The data store queue entry is freed up when the data is available in the data store queue entry and the data store queue is at the top of the queue. The partitioned store queue engine supports a load data stall extension that leverages an existing load data stall mechanism when the data store queue is full. For example, if the store instruction is in the memory stage of the processor pipeline and the data store queue is full, the partition store queue engine employs the load data stall to stall the processor pipeline.

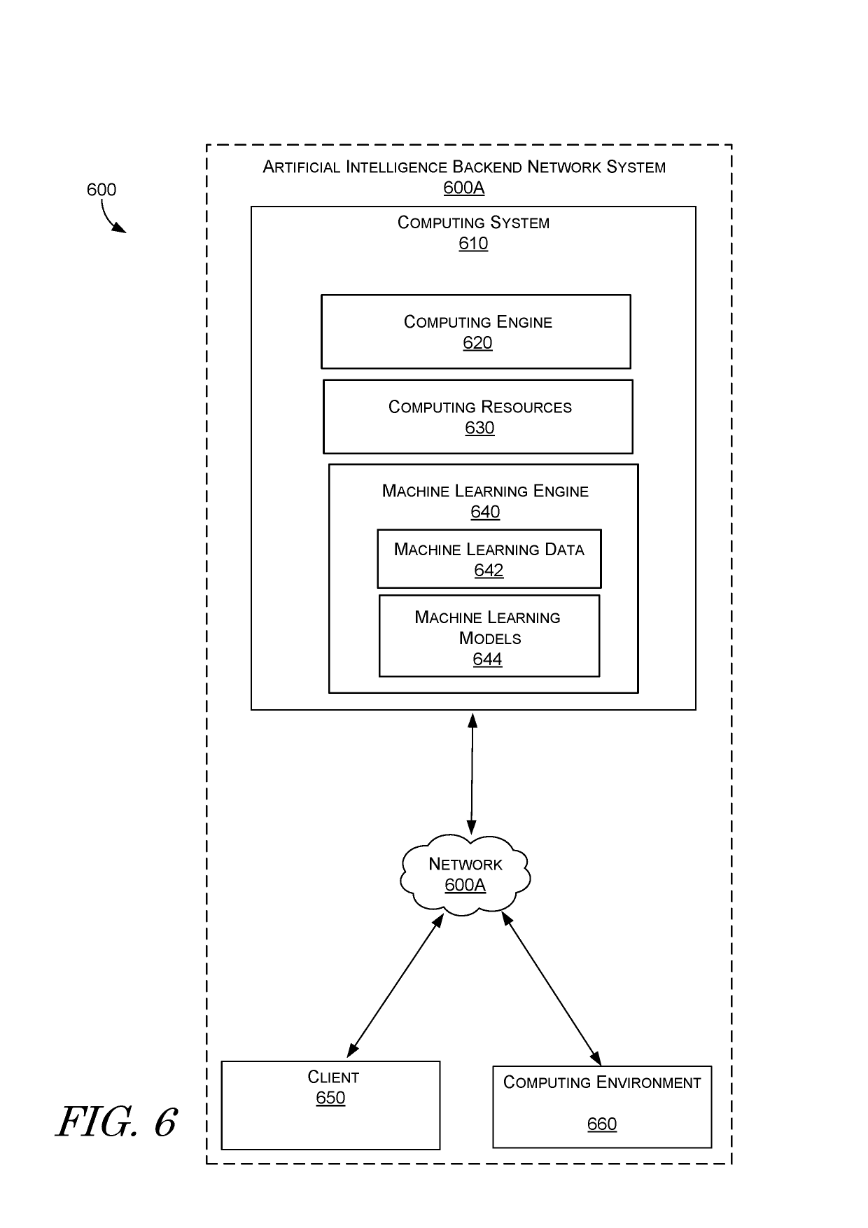

Aspects of the technical solution have been described by way of examples and with reference to FIGS. 1 and 2. FIG. 1 is a block diagram of an exemplary technical solution environment, based on example environments described with reference to FIGS. 6, 7 and 8 for use in implementing embodiments of the technical solution are shown. Generally the technical solution environment includes a technical solution system suitable for providing the example AI backend network system 100 in which methods of the present disclosure may be employed. In particular, FIG. 1 illustrates a high level architecture of the AI backend network system 100 in accordance with implementations of the present disclosure, among other engines, managers, generators, selectors, or components not shown (collectively referred to herein as “components”).

### EXAMPLE METHODS

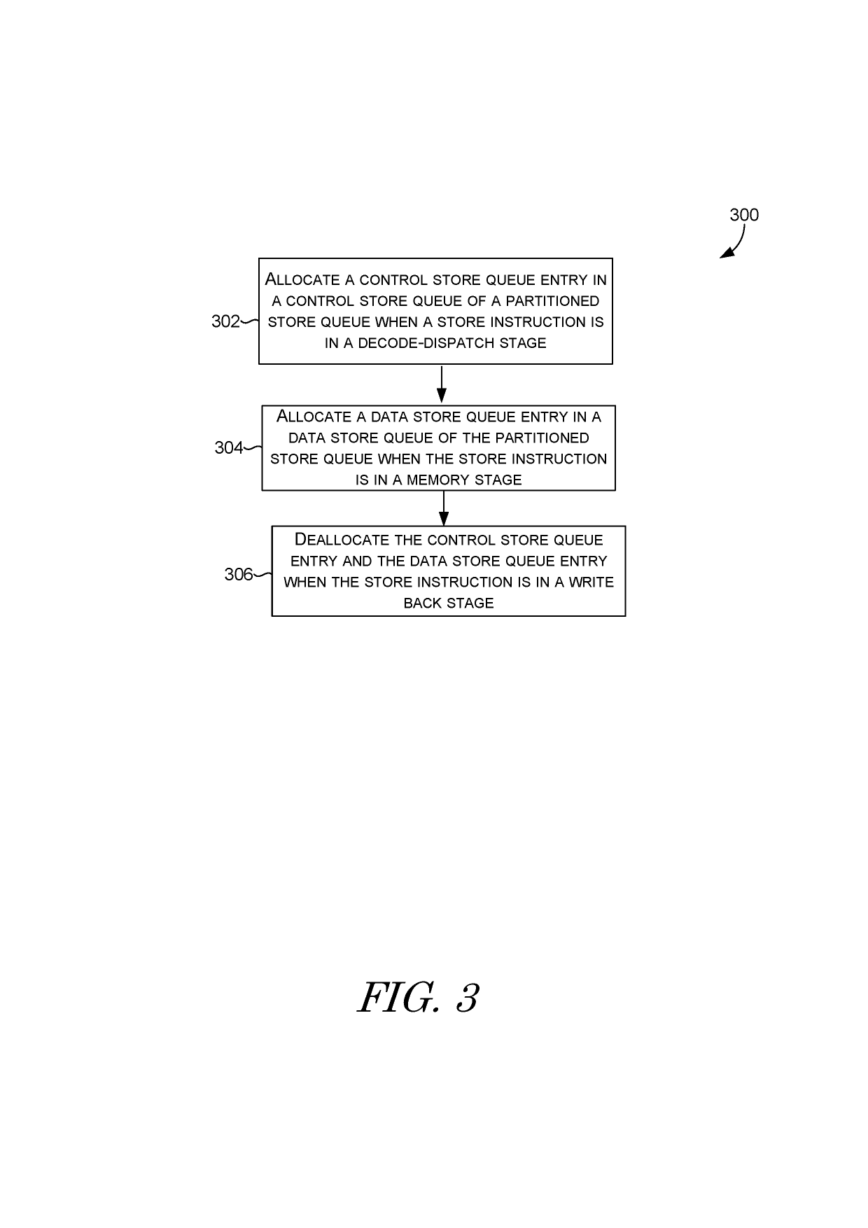

With reference to FIGS. 3, 4, and 5, flow diagrams are provided illustrating methods for providing partitioned store queue management using a partitioned store queue engine of a semiconductor system. The methods may be performed using the semiconductor system described herein. In embodiments, one or more computer-storage media having computer-executable or computer-useable instructions embodied thereon that, when executed, by one or more processors can cause the one or more processors to perform the methods (e.g., computer-implemented method) in the cloud access management system (e.g., a computerized system).

Turning to FIG. 3, a flow diagram is provided that illustrates a method 300 for providing partitioned store queue management using a partitioned store queue engine of a semiconductor system. At block 302, allocate a control store queue entry in a control store queue of a partitioned store queue when a store instruction is in decode-dispatch stage. At block 304, allocate a data store queue entry in a data store queue of the partitioned store queue when the store instruction is in a memory stage. At block 306, deallocate the control store queue entry and the data store queue entry when the store instruction is in a write back stage.

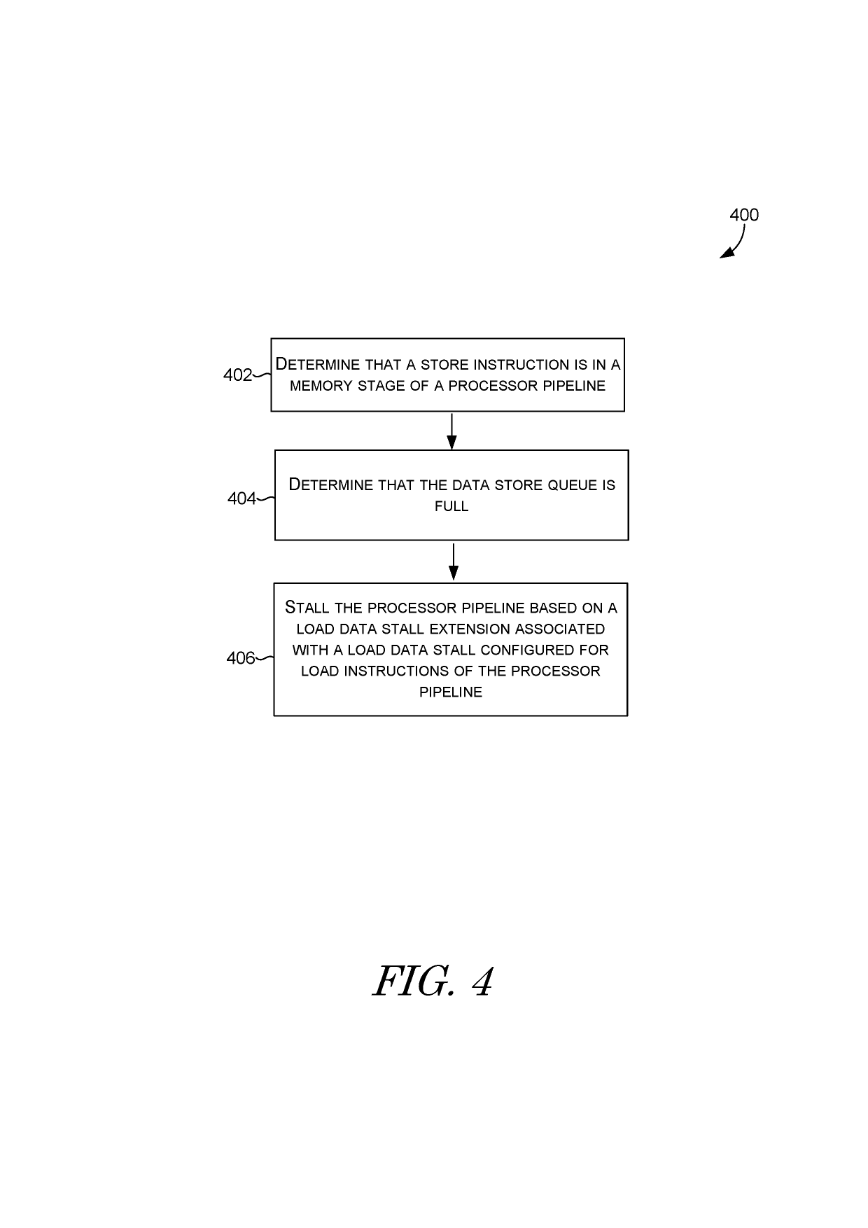

Turning to FIG. 4, a flow diagram is provided that illustrates a method 400 for providing partitioned store queue management using a partitioned store queue engine of a semiconductor system. At block 402, determine that a store instruction is in a memory stage of a processor pipeline. At block 404, determine that the data store queue is full. At block 406, stall the processor pipeline based on a load data stall extension associated with a load data stall configured for load instructions of the processor pipeline.

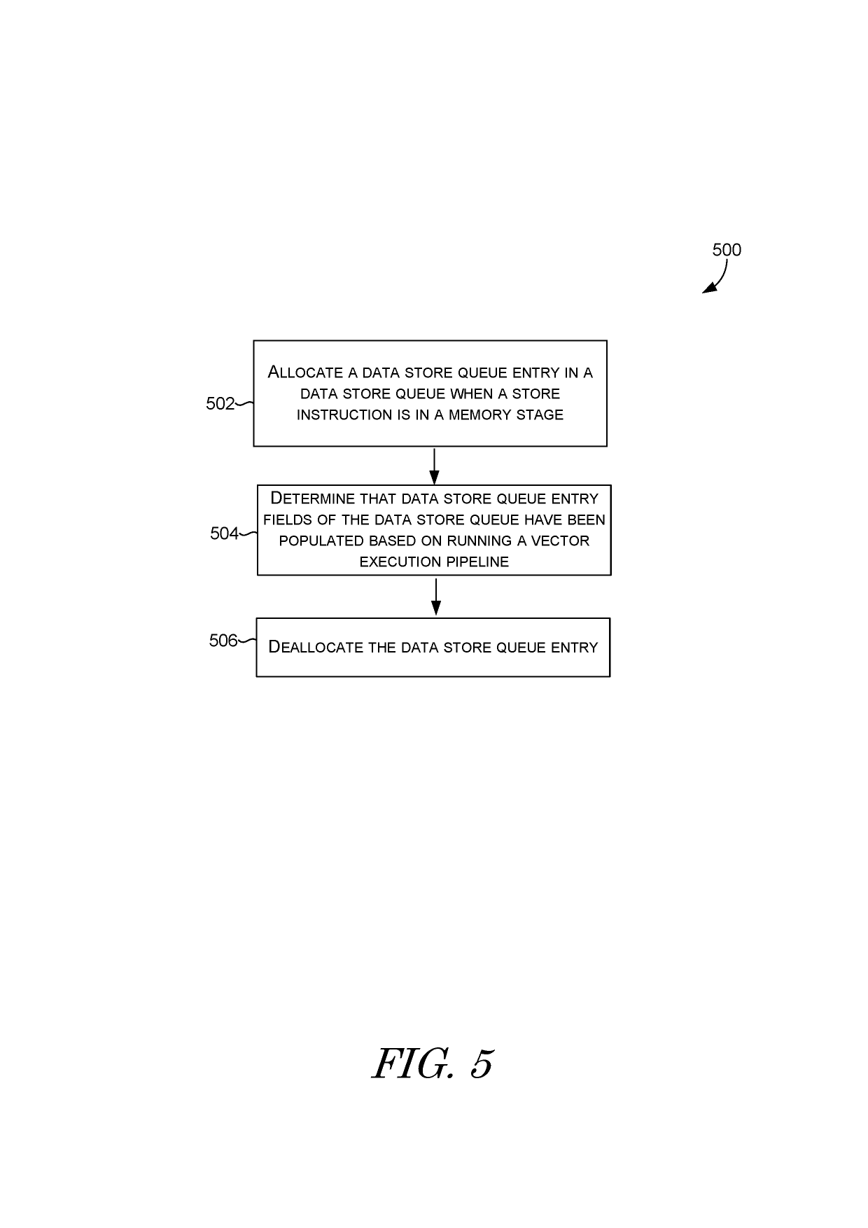

Turning to FIG. 5, a flow diagram is provided that illustrates a method 500 for providing partitioned store queue management using a partitioned store queue engine of a semiconductor system. At block 502, allocate a data store queue entry in a data store when a store instruction is in a memory stage. The data store queue is associated with a partitioned store queue comprising the data store queue and a control store queue associated with the processor pipeline. At block 504, determine that data store queue entry fields of the data store queue have been populated based on running a vector execution pipeline. At block 506, deallocated the data store queue entry.

### TECHNICAL IMPROVEMENT

Embodiments of the present techniques have been described with reference to several inventive features (e.g., operations, systems, engines, and components) associated with a semiconductor system. Inventive features described include: operations, interfaces, data structures, and arrangements of computing resources associated with providing the functionality described herein relative with reference to a partitioned store queue engine. Functionality of the embodiments of the present invention have further been described, by way of an implementation and anecdotal examples – to demonstrate that the operations for providing the partitioned store queue engine as a solution to a specific problem in storage queue in AI hardware technology to improve computing operations in semiconductor systems.

Advantageously, the embodiments of the present technical solution include several inventive features (e.g., operations, systems, engines, and components) associated with a partitioned store queue engine in a semiconductor system. Conventional systems often incorporate larger store queues to handle increased data traffic, resulting in a substantial increase in silicon area. This exponential silicon bloat necessitates feature reductions to manage the overall chip size and power consumption, which can compromise performance. The larger silicon area not only incurs higher manufacturing costs but also impacts thermal management and power efficiency, leading to a less optimal design. The increased silicon area requirement in conventional systems typically leads to performance degradation, as reducing the number of features often means decreasing the throughput capacity of the processor. This is particularly problematic for workloads requiring sustained high performance, as the system may not be able to handle the data efficiently, resulting in bottlenecks and reduced overall system efficiency.

In contrast, an area-optimal technical solution employs a more efficient design for the store queue (i.e., a partitioned store queue), minimizing silicon usage without sacrificing performance. By optimizing the store queue architecture, such solutions achieve sustained throughput necessary for demanding workloads without increasing the silicon area. This approach not only maintains high performance but also improves power efficiency and reduces thermal issues, making it a more viable and scalable option for advanced processors. The technical solution ensures that the AI hardware can manage high data traffic effectively, supporting robust performance while keeping design complexity and silicon area in check.

### ADDITIONAL SUPPORT FOR DETAILED DESCRIPTION

### EXAMPLE COMPUTING SYSTEM IN A COMPUTING ENVIRONMENT

Referring now to FIG. 6, FIG. 6 illustrates a computing environment in which implementations of the present disclosure may be employed. In particular, FIG. 6 shows a high level architecture of an example cloud computing platform 600, artificial intelligence (AI) backend network system 600A, and computing system 610 that can host a technical solution environment. It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

The cloud computing platform 600 provides computing system resources for different types of managed computing environments. For example, the cloud computing platform supports delivery of computing services – including compute, servers, storage, databases, networking, and intelligence. The components of cloud computing environment 600 may communicate with each other over a network 600A which may include, without limitation, one or more local area networks (LANs) and/or wide area networks (WANs).

The AI backend network system 600A provides a specialized infrastructure designed to support the computational demands of artificial intelligence (AI) workloads, including both training and inference tasks. The AI backend network systems 600A consists of interconnected components that facilitate the efficient processing, communication, and management of data into, out of, or between a distributed computing environment. Operations include data processing, handling input data, intermediate results, and output data, alongside complex computations for AI tasks, communication facilitating seamless interaction among components, and resource management overseeing optimal utilization of compute nodes, accelerators (e.g., GPUs, TPUs), memory, and storage. Interfaces encompass network interfaces enabling high-speed communication between nodes, APIs providing standardized interaction methods for developers, and management interfaces for system monitoring and administration. Data support functionalities include storage, data movement, transformation, and replication with backup mechanisms, ensuring data durability and reliability. In this way, the AI backend network system serves as the backbone infrastructure for AI workloads, facilitating efficient and scalable AI processing across distributed computing environments through its comprehensive operations, interfaces, and data management functionalities.

The cloud computing platform 600 provides the foundational infrastructure and resources for deploying and managing computing workloads, including AI. AI backend network system 600A includes specialized infrastructures tailored for supporting the unique computational demands of AI workloads. The relationship between the two involves resource provisioning, integration, orchestration, and data processing, enabling organizations to leverage cloud-based resources effectively for AI development and deployment.

The computing system 610 provides computing functionality for computing environments. For example, the computing system 610 is a platform or framework that leverages advanced technologies such as artificial intelligence (AI), machine learning (ML), data mining, and big data analytics to extract actionable insights and knowledge from large and complex datasets. In this way, the computing system 610 provides a computing environment that enables organizations to make informed decisions and optimize operations.

The computing system 610 includes a computing engine 620 that is a computing environment that supports executing computational tasks associated with the computing system 610. The computing engine 620 can be a hardware or software component that performs computational operations, such as, mathematical calculations, data processing, and algorithm execution. The computing system 610 integrates computing resources 630 into computing system 610 to effectively provide computing functionality in a computing environment.

The computing resources 630 refer to computing elements (e.g., components, capability, or entities) that collectively enable the computing engine 620 operations. The computing resources 630 encompass a spectrum of computing elements, beginning with the diverse operations the computing resources 630 can perform, ranging from complex computations to data manipulations. Interfaces, an integral part of the computing resources 630, provide the means for both user interaction and seamless integration with external systems, ensuring a dynamic and interactive computing experience. The data facet of the data computing resources 630 involves various types: input data, which is the information provided for processing; processing data, representing the data manipulated during computational tasks; and output data, the results generated by the computing engine 620. In this way, the computing resources 630 support the broader computing engine 620 and computing system 610.

Machine learning engine 640 is a machine learning framework or library that operates as a tool for providing infrastructure, algorithms, capabilities for designing, training, and deploying machine learning models. The machine learning engine 640 can include pre-built functions and APIs that enable building and applying machine learning techniques. The machine learning engine 640 can provide a machine learning workflow from data processing and feature extraction to model training, evaluation, and deployment.

Machine learning data 642 refers to the structured or unstructured information used to train, validate, and test machine learning models. This machine learning data 642 typically comprises input features (also known as independent variables or predictors) and their corresponding target values (also known as dependent variables or labels). Machine learning data 642 can come from various sources, such as databases, sensor readings, text documents, images, audio recordings, or streaming data sources. Machine learning data 642 may require preprocessing, cleaning, and transformation to ensure its suitability for training machine learning models. Additionally, machine learning data 642 is often divided into training, validation, and testing sets to assess the performance and generalization ability of trained models accurately.

Machine learning models 644 are algorithms or mathematical representations that learn patterns and relationships from the provided data to make predictions or decisions without being explicitly programmed. Machine learning models 644 models are trained using the machine learning data 642, where they iteratively adjust their internal parameters or coefficients to minimize prediction errors or maximize performance metrics. Machine learning models 644 can be classified into various types based on their learning algorithms and the nature of the problem they address, including supervised learning models (e.g., regression, classification), unsupervised learning models (e.g., clustering, dimensionality reduction), and reinforcement learning models. Once trained, machine learning models 644 can be deployed in production environments to make predictions on new, unseen data instances. Regular evaluation and monitoring of model performance are essential to ensure their accuracy, reliability, and effectiveness in real-world applications.

The computing client 650 supports access to computing system 610. The computing client 650 can be provided as a user client or an administrator client to support user and administrator functionality associated with the computing environment 660, computing engine 620, or computing system 610. The computing client 650 can also support accessing computing visualizations and causing display of the computing visualization. The computing client 650 can include a computing engine client that supports receiving computing information associated computing engine 620 output from the computing system 610 and causing presentation of the computing information. The computing information can specifically include computing visualizations associated with the computing engine 620 output.

Computing environment 660 is a computing environment that is integrated into the computing system 610. The computing environment 660 is characterized by an infrastructure, where data from various sources within the ecosystem, including servers, networks, applications, sensors, and user interactions, can be aggregated and processed by the computing system 610 to perform computing tasks. The computing environment 660 can be associated with middleware and integration layers facilitate seamless data flow, while computing infrastructure, encompassing cloud-based resources, distributed computing frameworks, and optimized storage systems, supports functionality associated with the computing.

### EXAMPLE DISTRIBUTED COMPUTING SYSTEM ENVIRONMENT

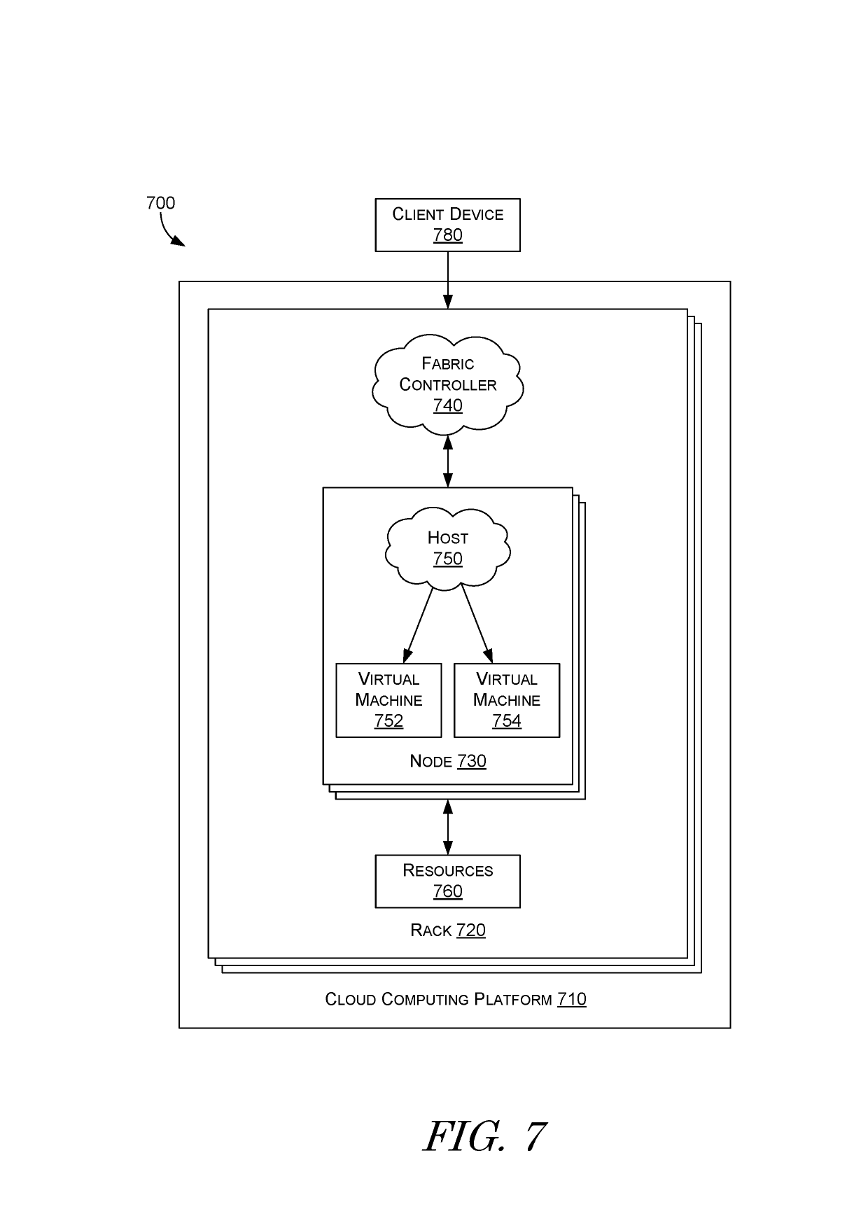

Referring now to FIG. 7, FIG. 7 illustrates an example distributed computing environment 700 in which implementations of the present disclosure may be employed. In particular, FIG. 7 shows a high level architecture of an example cloud computing platform 710 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 700 that includes cloud computing platform 710, rack 720, and node 730 (e.g., computing devices, processing units, or blades) in rack 720. The technical solution environment can be implemented with cloud computing platform 710 that runs cloud services across different data centers and geographic regions. Cloud computing platform 710 can implement fabric controller 740 component for provisioning and managing resource allocation, deployment, upgrade, and management of cloud services. Typically, cloud computing platform 710 acts to store data or run service applications in a distributed manner. Cloud computing infrastructure 710 in a data center can be configured to host and support operation of endpoints of a particular service application. Cloud computing infrastructure 710 may be a public cloud, a private cloud, or a dedicated cloud.

Node 730 can be provisioned with host 750 (e.g., operating system or runtime environment) running a defined software stack on node 730. Node 730 can also be configured to perform specialized functionality (e.g., compute nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 730, nodes 730 may be partitioned into virtual machines (e.g., virtual machine 752 and virtual machine 754). Physical machines can also concurrently run separate service applications. The virtual machines or physical machines can be configured as individualized computing environments that are supported by resources 760 (e.g., hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In particular, the servers may perform data operations independently but exposed as a single device referred to as a cluster. Each server in the cluster can be implemented as a node.

Client device 780 may be linked to a service application in cloud computing platform 710. Client device 780 may be any type of computing device, which may correspond to computing device 780 described with reference to FIG. 7, for example, client device 780 can be configured to issue commands to cloud computing platform 710. In embodiments, client device 780 may communicate with service applications through a virtual Internet Protocol (IP) and load balancer or other means that direct communication requests to designated endpoints in cloud computing platform 710. The components of cloud computing platform 710 may communicate with each other over a network (not shown), which may include, without limitation, one or more local area networks (LANs) and/or wide area networks (WANs).

### EXAMPLE COMPUTING ENVIRONMENT

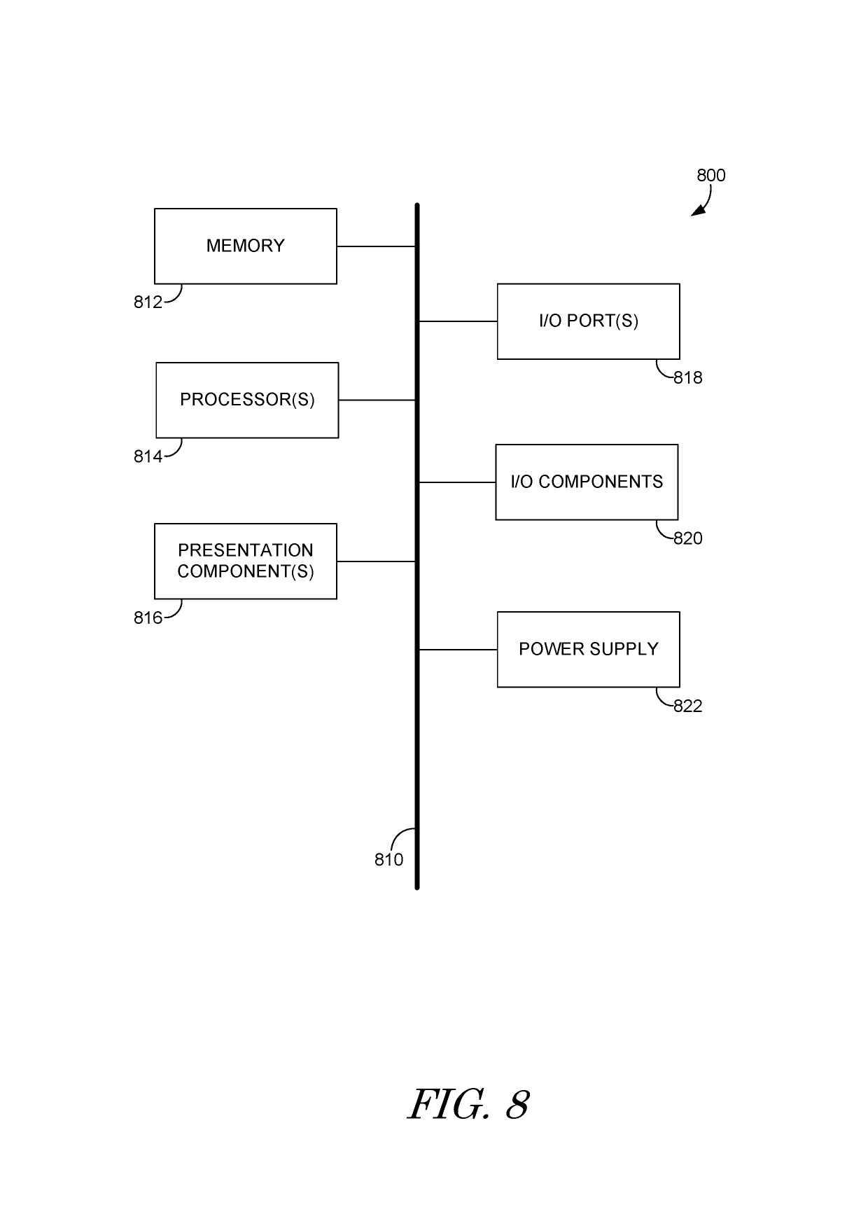

Having briefly described an overview of embodiments of the present technical solution, an example operating environment in which embodiments of the present technical solution may be implemented is described below in order to provide a general context for various aspects of the present technical solution. Referring initially to FIG. 8 in particular, an example operating environment for implementing embodiments of the present technical solution is shown and designated generally as computing device 800. Computing device 800 is but one example of a suitable computing environment and is not intended to suggest any limitation as to the scope of use or functionality of the technical solution. Neither should computing device 800 be interpreted as having any dependency or requirement relating to any one or combination of components illustrated.

The technical solution may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The technical solution may be practiced in a variety of system configurations, including hand-held devices, consumer electronics, general-purpose computers, more specialty computing devices, etc. The technical solution may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output ports 818, input/output components 820, and illustrative power supply 822. Bus 810 represents what may be one or more buses (such as an address bus, data bus, or combination thereof). The various blocks of FIG. 8 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 8 is merely illustrative of an example computing device that can be used in connection with one or more embodiments of the present technical solution. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

### ADDITIONAL STRUCTURAL AND FUNCTIONAL FEATURES

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technical solution is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technical solution are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present technical solution may generally refer to the technical solution environment and the schematics described herein, it is understood that the techniques described may be extended to other implementation contexts.

For purposes of this disclosure the word “support” refers to provisioning of functionality, services, or assistance by a computing component or through computing operations within a broader computing system. When a computing component or set of operations supports a specific functionality, it means that it plays a role in enabling or executing that particular aspect of the computing system. This support can manifest in various ways, including the processing of data, execution of operations, management of resources, and ensuring compatibility or interoperability with other components. Additionally, support may involve providing interfaces, APIs (Application Programming Interfaces), or protocols that allow seamless interaction and integration with other elements of the computing system. The concept of support extends beyond mere functionality provision to encompass maintenance, troubleshooting, and the overall optimization of computing resources to ensure the robust and efficient operation of the computing system.

Embodiments of the present technical solution have been described in relation to particular embodiments which are intended in all respects to be illustrative rather than restrictive. Alternative embodiments will become apparent to those of ordinary skill in the art to which the present technical solution pertains without departing from its scope.

From the foregoing, it will be seen that this technical solution is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A method, the method comprising:
allocating a control store queue entry in a control store queue of a partitioned
store queue when a store instruction is in a decode-dispatch stage of a processor pipeline;
allocating a data store queue entry in a data store queue of the partitioned store
queue when the store instruction is in a memory stage of the processor pipeline; and
deallocating the control store queue entry and the data store queue entry when the store instruction is in a write back stage of the processor pipeline.

2. The method of claim 1, wherein the processor pipeline is a sequence of stages in a vector processor that handles the fetching, decoding, execution of single instruction multiple data (SIMD) instructions, and memory operations, enabling parallel processing of multiple data elements simultaneously based on the partitioned store queue comprising the control store queue and the data store queue.

3. The method of claim 1, wherein a vector execution pipeline is run to populate data store queue entry fields when the data is available.

4. The method of claim 1, wherein the data store queue depth corresponds to a depth of stages of a vector execution pipeline.

5. The method of claim 4, wherein the depth of the stages of the vector execution pipeline depends on the following reading vector registers; latency of a vector execution unit, and pipeline stages required to move data to data store queues.

6. The method of claim 1, the method further comprising:
determining that a store instruction is in a memory stage of a processor pipeline, wherein the processor pipeline is associated with a partitioned store queue comprising a control queue and a data store queue;
determining that the data store queue is full; and
stalling the processor pipeline based on a load data stall extension associated
with a load data stall for load instructions associated with the processor pipeline.

7. The method of claim 6, wherein the load data stall extension is extended to operate with the data store queue, the load data stall extension halts the processor pipeline when it the data store queue full, wherein after the stall is resolved and the data store queue is no longer full, the processor pipeline resumes normal operation.

8. The method of claim 6, the method further comprising:
determining that the data store queue is no longer full; and
allocating a data store queue entry in the data store queue of the partitioned store
queue; and
deallocating the data store queue entry.

9. The method of claim 1, wherein the partitioned store queue enables achieving a throughput of one load and one store operation per cycles.

10. A method, the method comprising:
determining that a store instruction is in a memory stage of a processor pipeline, wherein the processor pipeline is associated with a partitioned store queue comprising a control queue and a data store queue;
determining that the data store queue is full; and
stalling the processor pipeline based on a load data stall extension associated
with a load data stall for load instructions associated with the processor pipeline.

11. The method of claim 10, wherein the load data stall extension is extended to operate with the data store queue, the load data stall extension halts the processor pipeline when it the data store queue full, wherein after the stall is resolved and the data store queue is no longer full, the processor pipeline resumes normal operation.

12. The method of claim 10, wherein the control store queue is associated with a control store queue entry that is allocated when the store instruction was in a decode-dispatch stage of the processor pipeline.

13. The method of claim 11, wherein the control store queue entry is deallocated when the store instruction is in a write back stage of the processor pipeline.

14. The method of claim 10, further comprising:
determining that the data store queue is no longer full;
allocating a data store queue entry in the data store queue of the partitioned store
queue; and
deallocating the data store queue entry.

15. A semiconductor system comprising:
a partitioned store queue associated with a processor pipeline;
a control store queue of the partitioned store queue, wherein a control store queue entry is allocated when a store instruction is in a decode-dispatch stage of the processor pipeline and deallocated when the store instruction in a write back stage of the processor pipeline; and
a data store queue of the partitioned store queue, wherein a data store queue entry is allocated when the store instruction is in memory stage of the processor pipeline and deallocated when the store instruction in the write back stage of the processor pipeline.

16. The semiconductor system of claim 15, wherein a vector execution pipeline is run to populate data store queue entry fields when the data is available.

17. The semiconductor system 15, wherein the data store queue depth corresponds to a depth of stages of a vector execution pipeline.

18. The semiconductor system of claim 17, wherein the depth of the stages of the vector execution pipeline depends on the following reading vector registers; latency of a vector execution unit, and pipeline stages required to move data to data store queues.

19. The semiconductor system of claim 15, further comprising a load data stall extension that is extended to operate with the data store queue, the load data stall extension halts the processor pipeline when it the data store queue full, wherein after the stall is resolved and the data store queue is no longer full, the processor pipeline resumes normal operation.

20. The semiconductor system of claim 19, wherein the load data stall extension is configured for:
determining that the store instruction is in the memory stage of the processor
pipeline;
determining that the data store queue is full; and
stalling the processor pipeline.
